(19) United States
(12) Patent Application Publication
(10) Pub. No.: US 2006/0222222 A1
(43) Pub. Date: Oct. 5, 2006

(54) Medical image processing apparatus and program

(75) Inventors: Hiroshi Fujita, Aisai-shi (JP); Ryujiro Yokoyama, Hashima-gun (JP); Satoshi Kasai, Tokyo (JP)

Correspondence Address: LUCAS & MERCANTI, LLP, 475 PARK AVENUE SOUTH, 15TH FLOOR, NEW YORK, NY, 10016, US

(73) Assignees: GIFU University; Konica Minolta Medical & Graphic, Inc.

(21) Appl. No.: 11/190,140

(22) Filed: Jul. 25, 2005

(30) Foreign Application Priority Data
Apr. 2, 2005 (JP) 2005-029141

(51) Int. Cl. G06K 9/00

(52) U.S. Cl. 382/128

(57) ABSTRACT

A medical image processing apparatus includes: an abnormal shadow candidate detection section for performing an image analysis of a medical image and for carrying out a detection of a candidate region for an abnormal shadow from the medical image; and a judgment section for setting only a candidate region detected in the medical image more than once as a final result of detecting an abnormal shadow candidate when the detection is carried out by the abnormal shadow candidate detection section more than once.

### BACKGROUND OF THE INVENTION

1. Field of the Invention

The present invention relates to a medical image processing apparatus performing an image analysis of a medical image and detecting a candidate region for an abnormal shadow.

2. Description of the Related Art

In a medical field, digitalization of medical images of patients is realized. At diagnosis, a doctor performs interpretation of digital medical image data displayed on a display and detects an abnormal shadow considered as a lesion. In recent years, for purposes of reducing a burden on the interpreting doctor and reducing missed abnormal shadows, medical image processing apparatus called computer aided diagnosis apparatus (hereinafter, referred to as CAD) performing image processing for medical images and automatically detecting abnormal shadow candidates have been developed.

Such CADs are disclosed in the following literatures:

Japanese Patent Laid-open Publication No. 2002-112986,

Hayashi Norio, et al., “A method of automatically extracting a cerebellum and an affected area in a head MRI image using morphology processing”, Journal of Medical Imaging and Information Sciences, vol21. no1. pp109-115, 2004,

Calli C. et al., “DWI findings of periventricular ischemic changes in patients with leukoaraiosis”, Comput Med Imaging Graph, vol27. no5. pp381-386, 2003.

The above CADs sometimes incorrectly judge shadows of normal tissue or benign lesions as abnormal shadows (hereinafter, the shadows incorrectly detected are referred to as false positive candidates). The appearance rate of false positive candidates varies depending on conditions for detecting the abnormal shadow candidates, and the conditions are relaxed in some cases when it is desired to detect every candidate that may be an abnormal shadow candidate. In this case, the number of false positive candidates tends to be large. However, the doctor has to check all the detected abnormal shadow candidates, and the excessive false positive candidates cause complication.

### SUMMARY OF THE INVENTION

An object of the present invention is to reduce the number of false positive candidates incorrectly detected and increase the accuracy in detecting abnormal shadow candidates.

To achieve the above object, according to a first aspect of the present invention, a medical image processing apparatus comprises:

an abnormal shadow candidate detection section for performing an image analysis of a medical image and for carrying out a detection of a candidate region for an abnormal shadow from the medical image; and

a judgment section for setting only a candidate region detected in the medical image more than once as a final result of detecting an abnormal shadow candidate when the detection is carried out by the abnormal shadow candidate detection section more than once.

According to the present invention, only the region highly likely to be the abnormal shadow can be outputted as the result of detecting the abnormal shadow candidate. Accordingly, the number of false positive candidates incorrectly detected can be reduced, and the accuracy in detecting the abnormal shadow candidates can be increased.

Preferably, the abnormal shadow candidate detection section carries out the detection more than once by one detection algorithm.

According to the present invention, even when the detection is performed by the one detection algorithm with, for example, a detection condition varied, the candidate region detected more than once is highly likely to be the abnormal shadow. Setting only such a candidate region as the detection result can reduce the number of false positive candidates incorrectly detected.

Preferably, the abnormal shadow candidate detection section sets a plurality of threshold values for judging whether a region is the candidate region for the abnormal shadow and carries out the detection more than once based on each threshold value, and

the judgment section sets only the candidate region detected by the abnormal shadow candidate detection section more than once with respect to each threshold value as a final result of detecting the abnormal shadow candidate.

According to the present invention, even when the detection is performed by the one detection algorithm with the threshold value for determining the candidate regions varied, only such candidate region detected more than once is set as the detection result. The number of false positive candidates incorrectly detected can be therefore reduced.

Preferably, the abnormal shadow candidate detection section carries out the detection using each of a plurality of detection algorithms, and

the judgment section sets only the candidate region detected more than once by the detection of the abnormal shadow candidate detection section using each of the plurality of detection algorithms as a final result of detecting the abnormal shadow candidate.

According to the present invention, a region detected as the candidate region for the abnormal shadow even by the plurality of algorithms is highly likely to be the abnormal shadow. Setting only such a region as the detection result can therefore reduce the number of false positive candidates incorrectly detected.

According to a second aspect of the present invention, a medical image processing apparatus comprises:

an abnormal shadow candidate detection section for performing an image analysis of a medical image and for carrying out a detection of a candidate region for an abnormal shadow from the medical image; and

an operation section for selecting any one of a first detection result in which only a candidate region detected in the medical image more than once is finally set as an abnormal shadow candidate and a second detection result in which a candidate region detected at least once is finally set as an abnormal shadow candidate, when the detection is carried out by the abnormal shadow candidate detection section more than once.

According to the present invention, one of the first and second detection results can be selected at doctor's request. Some doctors have a desire to reduce the number of false positive candidates as much as possible and check only candidates highly likely to be the abnormal shadow, and some doctors have a desire to check all the candidates that may be the abnormal shadow while allowing many false positive candidates to be included. In the case of the former desire, the first detection result including only the candidates detected more than once can be selected, and in the case of latter desire, the second detection result including the candidates detected at least once can be selected.

Preferably, the medical image processing apparatus further comprises a display section displaying the first or second detection result selected by the operation section.

According to the present invention, the doctor can check the selected and displayed detection result by the display section.

Preferably, the medical image processing apparatus further comprises a switching display section for switching the first or second detection result which is displayed by the display section to the other detection result to display the other detection result.

According to the present invention, the doctor can check either detection result when needed by switching the first and second detection results.

Preferably, the medical image processing apparatus further comprises an identification display section for displaying the detection result so as to identify that which the detection result is displayed between the first detection result and the second detection result, when the first or second detection result is displayed by the display section.

According to the present invention, the doctor can easily identify the detection result which is displayed.

Preferably, the identification display section displays the detection result so as to identify that which the detection result is displayed by using different colors, when the first or second detection result is displayed.

According to the present invention, the doctor can easily identify the detection result which is displayed, by colors.

Preferably, the identification display section displays the detection result so as to identify that which the detection result is displayed by using different types of maker information indicating the first or second detection result, when the first or second detection result is displayed.

According to the present invention, the doctor can easily identify the detection result which is displayed, by the marker information.

According to a third aspect of the present invention, a program allows the computer to realize:

a function for performing an image analysis of a medical image and for carrying out a detection of a candidate region for an abnormal shadow from the medical image by an abnormal shadow candidate detection section; and

a function for judging only a candidate region detected in the medical image more than once as a final result of detecting an abnormal shadow candidate when the detection is carried out by the abnormal shadow candidate detection section more than once.

According to the present invention, only the region highly likely to be the abnormal shadow can be outputted as the result of detecting the abnormal shadow candidate. Accordingly, the number of false positive candidates incorrectly detected can be reduced, and the accuracy in detecting the abnormal shadow candidates can be increased.

According to a fourth aspect of the present invention, a program allows the computer to realize:

a function for performing an image analysis of a medical image and for carrying out a detection of a candidate region for an abnormal shadow from the medical image by an abnormal shadow candidate detection section; and

a function for selecting any one of a first detection result in which only a candidate region detected in the medical image more than once is finally set as an abnormal shadow candidate and a second detection result in which a candidate region detected at least once is finally set as an abnormal shadow candidate, when the detection is carried out by the abnormal shadow candidate detection section more than once, and for outputting the selected detection result.

According to the present invention, one of the first and second detection results can be selected at doctor's request. Some doctors have a desire to reduce the number of false positive candidates as much as possible and check only candidates highly likely to be the abnormal shadow, and some doctors have a desire to check all the candidates that may be the abnormal shadow while allowing many false positive candidates to be included. In the case of the former desire, the first detection result including only the candidates detected more than once can be selected, and in the case of latter desire, the second detection result including the candidates detected at least once can be selected.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a diagram showing an internal configuration of a medical image processing apparatus in this embodiment;

FIG. 2A is a view showing an example of a T2-weighted image;

FIG. 2B is a view showing an example of a T1-weighted image;

FIG. 3 is a flowchart showing a flow of an abnormal shadow candidate detection process;

FIG. 4 is a flowchart showing a process flow in primary detection;

FIG. 5 is a view showing an image example of a shadow of lacunar infarction located at the periphery of a brain ventricle;

FIG. 6 is a view showing a brain parenchyma region extracted from the T1-weighted image;

FIG. 7 is a diagram showing an example of inner and outer circles used for calculating contrast between a region of lacunar infarction shadow candidate and a peripheral region;

FIG. 8 is a flowchart showing a flow of a result display process;

FIG. 9A is a view showing a display example of a first detection result; and

FIG. 9B is a view showing a display example of a second detection result.

### PREFERRED EMBODIMENT OF THE INVENTION

A description is given of an embodiment according to the present invention below with reference to the drawings.

In this embodiment, an example of detecting abnormal shadow candidates is described using medical images (hereinafter, referred to as MRI images) obtained by imaging with MRI apparatus.

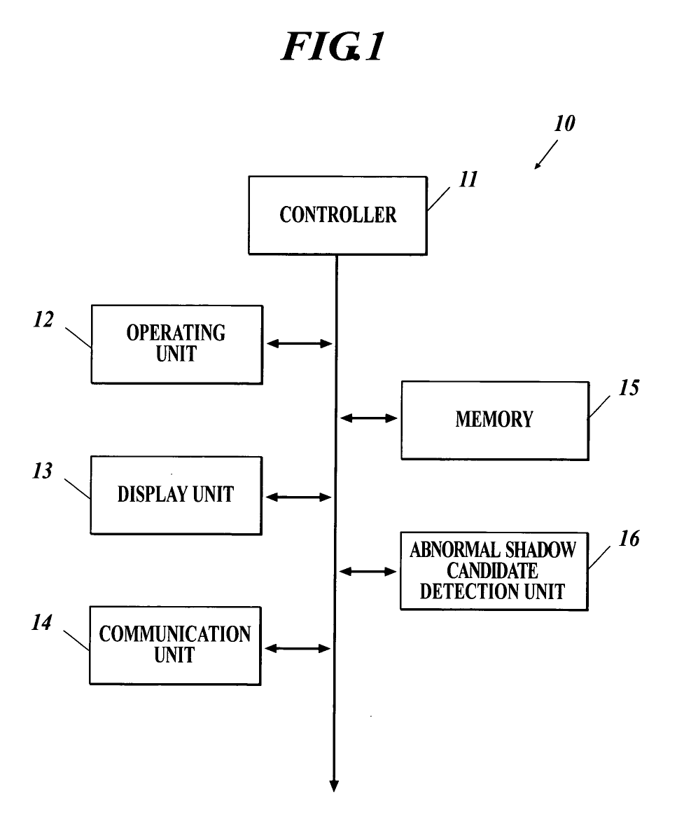

FIG. 1 shows an internal configuration of a medical image processing apparatus 10 in this embodiment.

As shown in FIG. 1, the medical image processing apparatus 10 includes a controller 11, an operating unit 12, a display unit 13, a communication unit 14, a memory 15, and an abnormal shadow candidate detection unit 16.

Next, a description is given of each member.

The controller 11 includes a central processing unit (CPU), a random access memory (RAM), and the like. The controller 11 reads various control programs from the memory 15 by means of the CPU and develops the same in the RAM for centralized control of operations of each member according to the control programs.

For example, upon receiving detection results from the abnormal shadow candidate detection unit 16, the controller 11 executes a later-described result display process to cause the display unit 13 to, according to a selection operation by the operation unit 12, display a detection result selected from a detection result including only candidates detected more than once and a detection result including only candidates detected at least once. When the controller 11 is instructed through the operation unit 12 to switch the detection results, the detection result being currently displayed is changed to the other detection result. The detection result is displayed such that it can be identified which detection result is currently being displayed. In other words, the cooperation of a result display processing program and the controller 11 can an implement switching display section and identification display section.

The operation unit 12 is an operation section including a keyboard composed of cursor keys, numeric keys, and various function keys and a pointing device such as a mouse and a touch panel. The operation unit 12 generates an operation signal corresponding to a key pressed or a mouse operation and outputs the same to the controller 11. Through this operation unit 12, the switching operation of the results of detecting the abnormal shadow candidates can be performed.

The display unit 13 is a display section including a liquid crystal display (LCD) or the like and, according to control by the controller 11, displays various display screens including medical images, results of detecting the abnormal shadow candidates by the abnormal shadow candidate detection unit 16, and a screen for changing detection conditions.

The communication unit 14 includes a communication interface such as a network interface card, a modem, and a terminal adapter and receives scanned medical images from various types of imaging apparatus such as MRI apparatus and computed radiography (CR) apparatus connected through a LAN inside a hospital. The communication unit 14 may be connected to and receives the medical images from, not limited to the imaging apparatus, medical image generation apparatus such as a laser digitizer scanning a film having a medical image recorded thereon by means of laser light and reading the medical image and a film scanner reading a medical image recorded on a film by means of a sensor composed of a photoelectric transducer such as a charged coupled device (CCD). In addition, the communication unit 14 may be configured so as to be connected to a flat panel detector composed of a capacitor and a radiation detector generating charges according to intensity of irradiated radiation, and the like.

The way of inputting the medical images is not limited to communication. For example, it can be configured to provide an interface for connecting the medical image generation apparatus and input medical images generated in the above various types of medical image generation apparatus through the above interface into the medical image processing apparatus 10.

The medical image processing apparatus 10 may be configured to be connected to a terminal for interpretation placed in each examination room through the communication unit 14 and send the results of detecting the abnormal shadow candidates to the terminal.

The memory 15 stores the various control programs executed in the controller 11, an abnormal shadow candidate detection program executed in the abnormal shadow candidate detection unit 16, data processed by each program, parameters used in the abnormal shadow candidate detection process, and the like.

The abnormal shadow candidate detection unit 16 is an abnormal shadow candidate detection section for performing an image analysis of medical images inputted through the communication unit 14 and detecting regions highly likely to be the abnormal shadow from the medical images as the abnormal shadow candidates.

The abnormal shadow candidate detection unit 16 includes a CPU, a RAM, and the like. The abnormal shadow candidate detection unit 16 reads the abnormal shadow candidate detection program from the memory 15 and executes the later-described abnormal shadow candidate detection process in cooperation with the program. The abnormal shadow candidate detection unit 16 thus carries out various operations to detect primary candidates for the abnormal shadow, detect false positive candidates, and sets the candidates remaining after removing the false positive candidates from the primary candidates as a result of detecting the abnormal shadow candidates. In other words, the abnormal shadow candidate detection unit 16 can an implement judgment section in the cooperation with the abnormal shadow candidate detection program.

Hereinafter, a description is given of the abnormal shadow candidate detection process executed by the abnormal shadow candidate detection unit 16 with reference to the drawing. In this embodiment, the description is given of an example of detecting abnormal shadow candidates (hereinafter, referred to as lacunar infarction shadow candidates) for lacunar infarction causing cerebral infarction using T1-weighted and T2-weighted images which are MRI images of a head of a patient taken by the MRI apparatus under different imaging conditions. The lacunar infarction occurs when a blood flow in a thin blood vessel called a perforating artery in a brain stops and cells downstream become necrotic.

First, the T1-weighted and T2-weighted images used for the detection are described. The T1-weighted and T2-weighted images are general medical images used when a doctor makes a diagnosis of lacunar infarct, which are taken by the MRI apparatus.

The MRI is a technique to obtain an image utilizing nuclear magnetic resonance (hereinafter, referred to as NMR) in a magnetic field.

In the NMR, a body to be examined is put in a magnetostatic field and then is irradiated by radio waves having the resonant frequency of an atomic nucleus targeted for detection in the body being examined. Medical applications usually use the resonant frequency of a hydrogen atom constituting water highly included in a human body. When the body being examined is irradiated by radio waves, an excitation phenomenon occurs, and phases of nuclear spins of atoms resonating with the resonant frequency are aligned. Simultaneously, the nuclear spins absorb energy of the radio waves. When the irradiation of the radio waves is stopped in this excitation state, a relaxation phenomenon occurs, and the phases of the nuclear spins become misaligned while the nuclear spins release the energy. The time constant in terms of the phase relaxation is T1, and the time constant in terms of the energy relaxation is T2.

These values T1 and T2 affect the contrast of MRI images. Image signals of tissue having smaller T1 or larger T2 have higher signal intensity. An image taken under an imaging condition at a scan adjusted so that this T1 becomes small is the T1-weighted image, and an image taken under an imaging condition at a scan adjusted so that this T2 becomes large is the T2-weighted image.

Each human body tissue includes specific T1 and T2 values, and a combination of the T1-weighted and T2-weighted images allows specification of the tissue. Generally, with the T1-weighted image, an anatomic structure can be easily recognized. In the T2-weighted image, many types of lesions appear white. The T2-weighted image is therefore often used for detecting lesions.

As for brain tissue, the T1-weighted image includes higher signals (whiter and less dense in the image) in the order of: fat>brain white matter>brain gray matter>water (cerebrospinal fluid or the like). On the contrary, the T2-weighted image includes lower signals (blacker and denser in the image) in the above order.

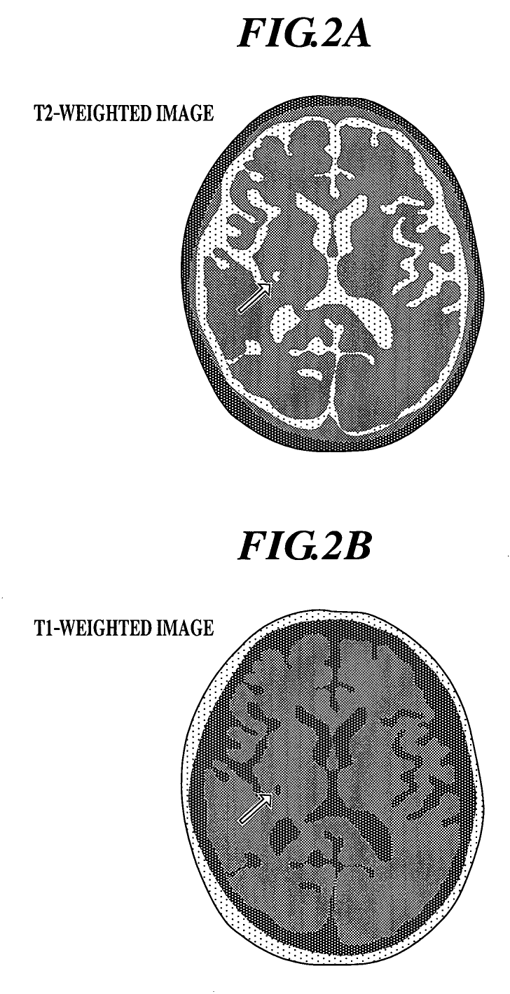

As shown in examples of the T1-weighted and T2-weighted images in FIGS. 2A and 2B, a brain parenchyma region (indicating a part of the brain (within a pia mater) other than a ventricle, which is of white and gray matters in a cerebellum and a cerebrum including a brain stem and a basal ganglion) includes high intensity signals and appears white in the T2-weighted image while including low intensity signals and appearing black in the T1-weighted image. On the other hand, since lacunar infarction is an edema containing water, the lacunar infarction provides high signals in the T2-weighted image (low density region indicated by an arrow in FIG. 2A) and providing low signals in the T1-weighted image (high density region indicated by an arrow in FIG. 2B). Moreover, lacunar infarction is located at the periphery of the brain ventricle in the brain parenchyma region and appears as a circular shadow on the image at intensity different from that of the peripheral region thereof.

Next, a description is given of operations of the above medical image processing apparatus 10.

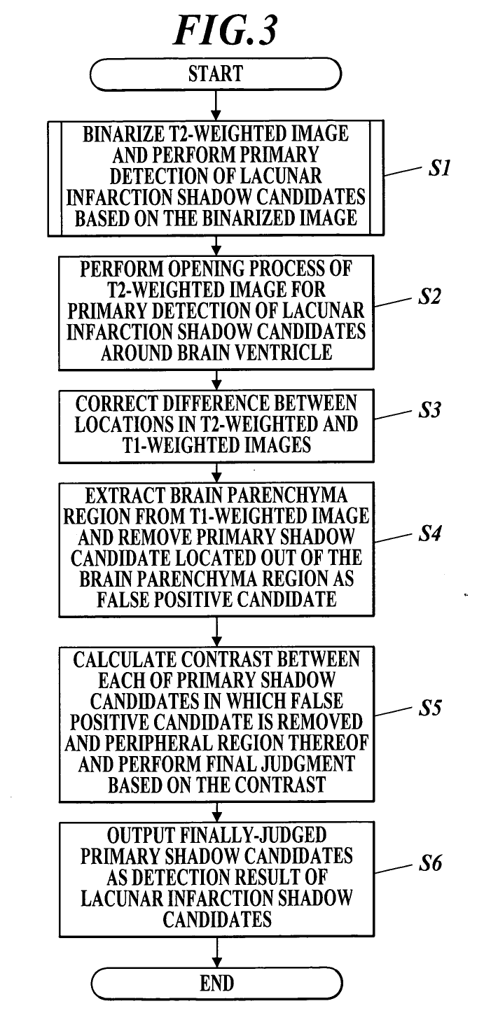

First, with reference to FIG. 3, a description is given of the abnormal shadow candidate detection process to detect candidate regions for the lacunar infarction shadow using the T1-weighted and T2-weighted images in the abnormal shadow candidate detection unit 16. Parameters used in the process, such as threshold values, are properly read from the memory 15 for use.

In the abnormal shadow candidate detection process shown. in FIG. 3, first, the T2-weighted image is binarized, and then primary detection of the lacunar infarction shadow candidates from the binarized images is performed (step S1). Generally, disease stages of lacunar infarction are separated into an acute stage, a subacute stage, and a chronic stage, and pixel values of the MRI image vary depending on the stages. The pixel values also vary depending on differences in the imaging conditions. The binarization of the T2-weighted image is therefore performed with the threshold value varied by increments of 10 in a range of, for example, −45 to +25 around an average pixel value of the brain ventricle region.

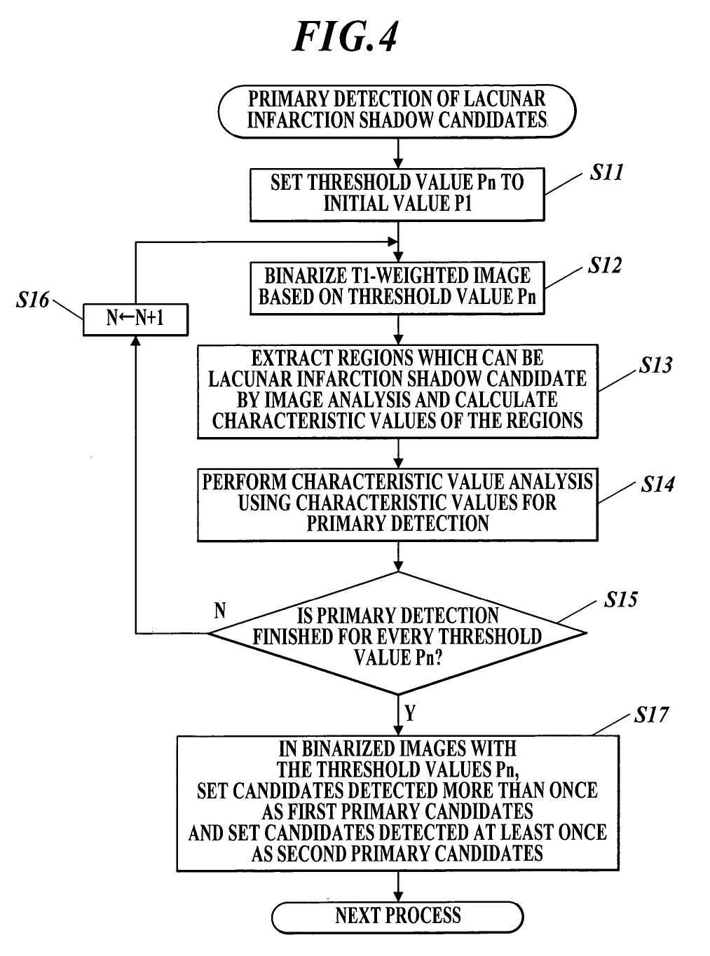

The step of the primary detection by the binarization is described in more details with reference to FIG. 4.

The threshold value varied is Pn (n=1, 2 . . . ). First, a parameter n of the threshold value Pn is set to an initial value n=1 (step S11). Subsequently, the T2-weighted image is binarized based on the threshold value Pn (step S12). This binarized image is then subjected to an image analysis to extract the candidate regions for the lacunar infarction shadow, and the image characteristic values (hereinafter, just referred to as characteristic values) in the extracted regions are calculated (step S13).

In a binarized image, the lacunar infarction shadow is expected to have a circular shape with a diameter of about 3 to 10 mm. Moreover, it is expected that the pixel values within the region are 0 while the pixel values in the brain parenchyma region therearound are 1. Accordingly, regions having such a characteristic density property are detected, and then image characteristic values such as circularity and area of the detected regions are calculated. Using the calculated characteristic values, the primary detection of the lacunar infarction shadow candidates is performed by a characteristic value analysis, such as discriminant analysis, carried out using an actual lacunar infarction shadow as sample data (step S14).

Subsequently, it is judged whether the primary detection is already finished for the binarized images by each threshold values Pn (step S15). When the primary detection is not finished yet (N in step S15), the parameter n of the threshold value Pn is incremented by +1 (step S16), and the process returns to the step S12. Then, the primary detection is repeated for the next threshold value Pn.

After the binarization is performed in terms of all the prepared threshold values Pn and the primary detection using the thus binarized images is finished as described above (Y in step S15), based on the center of gravity of each lacunar infarction shadow candidate detected in each binarized image, the lacunar infarction shadow candidates detected within a certain range from the center of gravity in the binarized images more than once are set as first primary candidates. The lacunar infarction shadow candidates detected in the binarized images at least once are set as second primary candidates (step S17). In other words, the first primary candidates are always included in the second primary candidates which are detected at least once. After the first or second primary candidates are determined as described above, the process proceeds to a process of the step S2 shown in FIG. 3.

In the step S2, the T2-weighted image is subjected to an opening process to perform primary detection of the lacunar infarction shadow candidates located at the periphery of the brain ventricle, which are not detected in the step S1 (step S2).

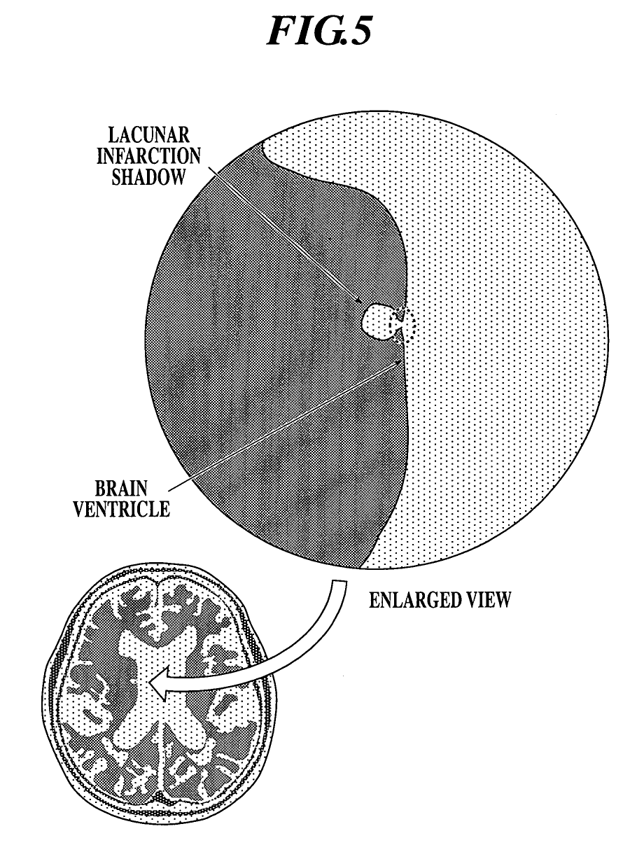

The lacunar infarction shadows are often located in the vicinity of the brain ventricle. When lacunar infarction is located in adjacent to the brain ventricle, as shown in FIG. 5, the image of the lacunar infarction shadow sometimes appears partially merged with the image of the brain ventricle since the brain ventricle has low density on the T2-weighted image similar to the lacunar infarction shadow. In such a case, the lacunar infarction shadow is treated as a part of the brain ventricle and is difficult to detect in the detection method of the step S1. Accordingly, detection of lacunar infarction shadow candidates is performed after the region of the lacunar infarction shadow part of which protrudes from the brain ventricle is separated from the region of the brain ventricle by the opening process.

Specifically, difference between images of circles with radii of 1 and 8 subjected to the opening process is calculated, and the characteristic value analysis is then performed to detect the lacunar infarction shadow candidate.

The detected lacunar infarction shadow candidates are added to the first and second primary candidates detected in the step S1.

Processes in the following steps S3 to S5 are separately performed for the first and second primary candidates.

After the primary candidates are detected, the difference in positions between the T2-weighted and T1-weighted images is corrected based on location information of the detected primary candidates (step S3).

As for the lacunar infarct, necrotic cells and cells affected by the same are both imaged on the T2-weighted image with low density while information of only the necrotic cells is mainly imaged on the T1-weighted image. Accordingly, lacunar infarction shadows appearing in the T1-weighted and T2-weighted images are different from each other in size and shape in many cases, and the centers of gravity thereof also do not match in many cases. In the region of each primary candidate detected on the T2-weighted image, the center of a 3×3 pixel having a minimum average pixel value in the region of 13×13 pixels is calculated. The position of the calculated center is specified as the center of the gravity of the primary candidate in the T1-weighted image. The difference in positions between the T2-weighted and T1-weighted images is therefore corrected.

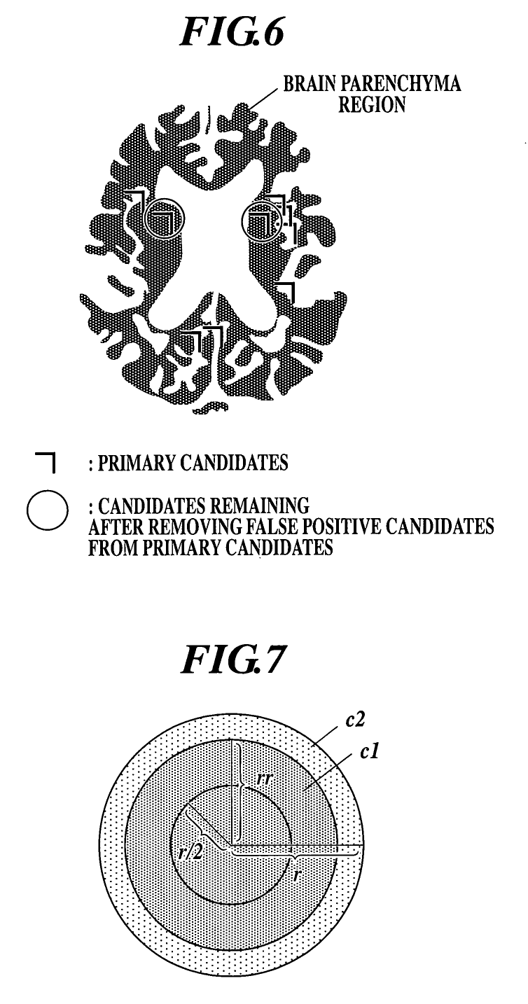

After the difference in positions is corrected, the brain parenchyma region is extracted from the T1-weighted image. The primary candidates located in the brain parenchyma region are then detected as the false positive candidates and removed from the primary candidates (step S4). The brain parenchyma region is extracted by a region growing method with a most-frequent density value set as a region growing seed point which is calculated based on a density histogram obtained from the T1-weighted image. FIG. 6 shows an example of the extracted brain parenchyma region. In FIG. 6, a black region with low density is the brain parenchyma region. Since a lacunar infarction shadow is located in the brain parenchyma region, the primary candidates detected in regions other than the extracted brain parenchyma region, including cerebral sulci and a limbic part, can be judged as the false positive candidates. Based on the positions of the centers of gravity of the primary candidates specified in the T1-weighted image, the false positive candidates in the primary candidates are detected and removed from the primary candidates.

Subsequently, the contrast between the region of each primary candidate and the peripheral region thereof is calculated in the T1-weighted image, and a final judgment is carried out based on the calculated contrast whether the primary candidate is the lacunar infarction shadow candidate (step S5). As previously described, in the T1-weighted image, the brain parenchyma region has slightly high density, and the lacunar infarction shadow has higher density than that of the brain parenchyma region. When detecting lacunar infarct, the doctor usually relatively observes the contrast between a region thought to be lacunar infarction and the peripheral region thereof and discriminates whether the region thought to be lacunar infarction is especially different from the peripheral region.

As shown in FIG. 7, two types of circles, which are an inner circle C1 representing the region of the lacunar infarction shadow and an outer circle C2 representing the peripheral region thereof, are calculated based on the center of gravity and area of the region of each primary candidate. The difference between the average pixel values in the inner circle region and in a region obtained by subtracting the inner circle region from the outer circle region is calculated as the contrast. When the contrast is not less than a threshold value, the primary candidate is finally judged as the lacunar infarction shadow region. The threshold concerning the contrast is experimentally obtained in advance and stored in the memory 15. In the process, the contrast is read from the memory 15.

As described above, after the final judgment is carried out for each of the first and second primary candidates, the first and second primary candidates finally judged as the lacunar infarction shadow region are outputted to the controller 11 as the result of detecting the lacunar infarction shadow candidates (step S6).

In the controller 11 having received the result of detecting the lacunar infarction shadow candidates from the abnormal shadow candidate detection unit 16, a result display process to display the detection result is carried out.

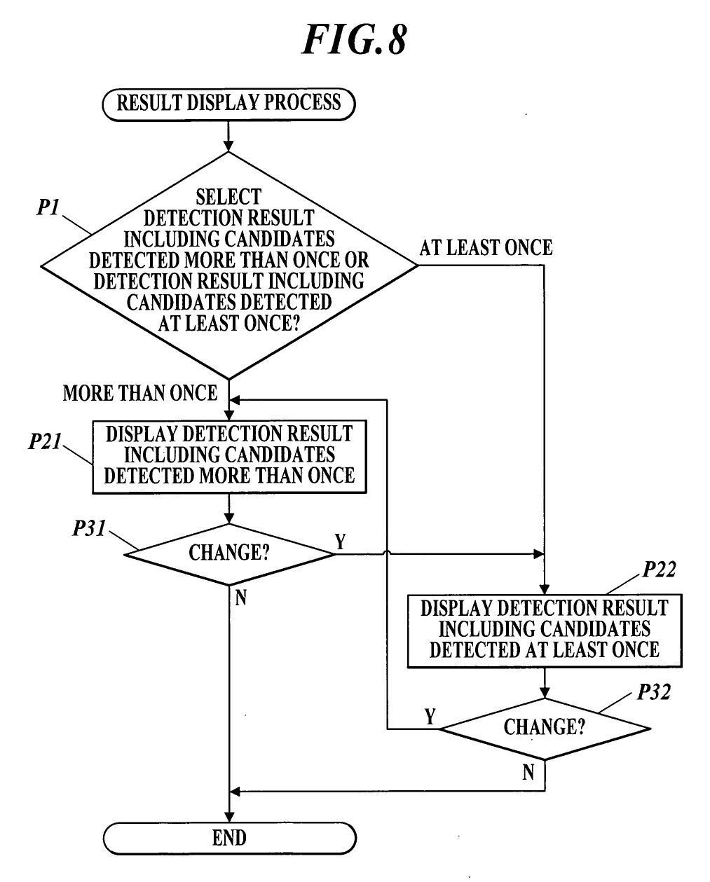

With reference to FIG. 8, the result display process is described.

In the result display process shown in FIG. 8, first, a selection screen (not shown) is displayed on the display unit 13. The selection screen is for selecting one detection result to be displayed from a first detection result in which only the candidate regions detected more than once by the abnormal shadow candidate detection unit 16 are judged as the abnormal shadow candidates and a second detection result in which the candidate regions detected at least once are judged as the abnormal shadow candidates.

When the first detection result is selected through the operation unit 12 in the selection screen (step P1; detected more than once), the first detection result, that is, the detection result obtained by judging the candidate regions remaining after removing the false positive candidates from the first primary candidates as the abnormal shadow candidates, is displayed on the display-unit 13 (step P21).

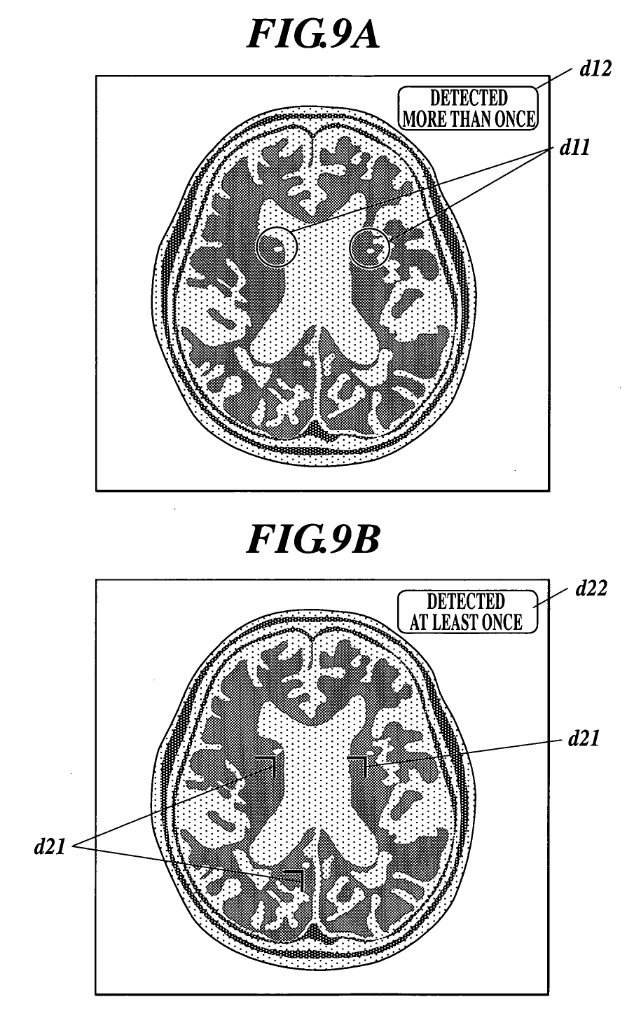

FIG. 9A shows a display example thereof.

As shown in FIG. 9A, marker information circles dll indicating parts judged as the candidate regions for the abnormal shadow in the first detection result are synthesized and displayed on the T2-weighted image. Moreover, a message d12 is displayed in an upper portion of the screen such that it can be identified that the detection result being currently displayed is the result (first detection result) including the candidate regions detected more than once.

On the other hand, when the second detection result is selected (step P1; detected at least once), the second detection result, that is, the detection result obtained by judging the candidate regions remaining after removing the false positive candidates from the second primary candidates as the abnormal shadow candidates, is displayed on the display unit 13 (step P22).

FIG. 9B shows a display example thereof.

As shown in FIG. 9B, marker information arrows d21 indicating parts judged as the candidate regions for the abnormal shadow in the second detection result are synthesized and displayed on the T2-weighted image. Moreover, a message d22 is displayed in an upper portion of the screen such that it can be identified that the detection result being currently displayed is the result (second detection result) including the candidate regions detected at least once.

Furthermore, as shown in FIGS. 9A and 9B, the controller 11 displays the markers different depending on the displayed display result such that it can be identified whether the detection result being currently displayed is the first or second detection result. Herein, the markers have different shapes, but the markers may have different colors or sizes so as to be identified.

Subsequently, when, while selected one of the detection results is displayed, an instruction is given by the operation unit 12 to switch the display to the other detection result (step P31, P32), in the case where the first detection result is displayed the process proceeds to the process of the step P22 to switch the display to the second detection result, and in the case where the second detection result is displayed, the process proceeds to a process of step P21 to switch the display to the first detection result.

As described above, according to the embodiment, in the primary detection of the lacunar infarction shadow candidates, the detection is carried out for each of the binarized images obtained with the threshold value for binarization varied, and only the candidate regions detected more than once are finally judged as the lacunar infarction shadow candidates. Accordingly, it is possible to output the candidates highly likely to be the lacunar infarction shadow as the detection result. The number of false positive candidates incorrectly detected can be therefore reduced, and the accuracy in detecting the lacunar infarction shadow candidates can be increased.

Moreover, the detection result to be displayed can be selected out of the first detection result including the candidates detected more than once by the primary detection and the second detection result including the candidates detected at least once. When it is desired to refer to the detection result with high detection accuracy including few false positive candidates, the first detection result is selected. When it is desired to detect the candidate regions which may be the lacunar infarction shadow as much as possible while allowing some false positive candidates to be included, the second detection result is selected. The doctor can therefore obtain a desired detection result.

Moreover, the display of the first and second detection results can be switched. Accordingly, the doctor can compare and examine the both detection results.

Furthermore, the first and second detection results are displayed so as to be identified by the markers or messages. Accordingly, even when the display is switched, the doctor can easily understand which detection result is currently being displayed.

The medical images used for detecting the lacunar infarction shadow candidates are the T1 -wighted and T2-weighted images generally taken at MRI diagnosis, which removes the need for separately taking a special image for the detection process by the medical image processing apparatus 10. Accordingly, the burden on a patient as the body being examined can be minimized. Moreover, the detection is performed using the same image as the doctor uses for diagnosis, and the doctor can compare the detection result by the medical image processing apparatus 10 with the doctor's diagnosis.

The aforementioned medical image processing apparatus 10 is just a preferable example to which the present invention is applied.

For example, in the above description, the candidates are detected using a piece of the T1-weighted image and a piece of the T2-weighted image. However, the detection may be performed using, not limited to this, a plurality of the T1-weighted images and a plurality of the T2-weihted images, which are taken with the imaging conditions varied to have different parameter values T1 and T2. In this case, the primary detection is performed for each of the plurality of T2-weighted images, and the false positive candidates are detected using the plurality of T1-weighted images from the primary candidates detected from every image. This can increase the detection accuracy in the primary detection and the accuracy in detecting the false positive candidates, and the combination thereof can increase the accuracy in detecting the lacunar infarction shadow candidates.

The above embodiment is provided with the plurality of threshold values for binarization and carries out the detection more than once. The embodiment may be, not limited to this, provided with a plurality of threshold values for the characteristic value analysis and carry out the characteristic value analysis more than once.

Furthermore, the detection is carried out more than once with the threshold value varied in the detection algorithm by binarization. However, the detection may be carried out separately by several types of detection algorithms, such as the detection algorithm by binarization and a detection algorithm by the characteristic value analysis, and the candidate regions detected more than once in any one of the detection algorithms are judged as the primary candidates.

In this case, if the detection result by a plurality of detection algorithms and the detection result by a single detection algorithm can be switched to be displayed, the following effects can be obtained in terms of clarification and simplification of the detection algorithms.

For example, a case is considered, where a shadow targeted for detection is a region which is round, sawtooth-shaped at the periphery, and inhomogeneous in internal density, and algorithms of detecting a round shadow, detecting a region including a mass of small dots, and detecting a region with inhomogeneous internal density are separately prepared in the medical image processing apparatus. In this case, the doctor can think that the medical image processing apparatus can carry out detection of the targeted shadows by a process to detect a round shadow, a process to detect a mass of small dots, and a process to detect a region with inhomogeneous density and can easily understand the contents of the algorithms. However, the case of such a detection method includes a problem of an increase in the number of false positive candidates incorrectly detected.

On the other hand, in the case where only one complicated algorithm is prepared, which detects a region which is round, sawtooth-shaped at the periphery, and inhomogeneous in internal density by totally judging these characteristics, the error detection rate of the false positive candidates is reduced. However, it is difficult for the doctor to understand the contents of the algorithm, such as what conditions the medical image processing apparatus performs the detection under. This leads to a problem that makes it difficult for the doctor to use the detection logic in interpretation as reference.

Accordingly, if the display can be switched between the detection results, like between the detection result by the plurality of algorithms and the detection result by a single algorithm, a detection result with higher accuracy can be supplied to the doctor with the detection result by the plurality of algorithms, and a function of each algorithm can be simplified with the detection result by one algorithm (in other word, one algorithm can be specialized to one detection target, like the algorithm to each algorithm of the process to detect a round region, the process to detect a region including a mass of small dots, and the process to detect a region with inhomogeneous internal density in the above example). It is therefore possible to propose detection logic with an easy-to-understand algorithm.

Moreover, the candidates detected more than once or the candidates detected at least once can be selected for display, and the candidates are displayed such that it can be identified which detection result is being displayed. However, the display may be selected from, not limited to this, the candidates detected more than once and the candidates detected only once. In this case, the candidates detected more than once are highly likely to be the true lacunar infarction shadow, and the candidates detected only once are less likely to be the lacunar infarction candidate than the candidates detected more than once. It is therefore possible to show the risk by identifying the candidates detected more than once with red markers and the candidates detected only once with blue markers.

In the aforementioned embodiment, the description is given of the example of detecting the lacunar infarction shadow candidates from the MRI images of a head, but the present invention can be applied to detection of other abnormal shadow candidates concerning to another part. For example, in the case of detecting tumor shadows and minute calcified clusters which are findings of breast cancer, from an X-ray image obtained by imaging breasts by means of the CR apparatus, a plurality of X-ray images with different imaging conditions are taken. The primary detection for the tumor shadows and the like is performed for each of the plurality of X-ray images. The false positive candidates may be detected using any one of the X-ray images and removed from the primary candidates detected from the X-ray images more than once.

The entire disclosure of a Japanese Patent Application No. 2005-29141, filed on Feb. 4, 2005, including specifications, claims, drawings and summaries are incorporated herein by reference in their entirety.

What is claimed is:

1. A medical image processing apparatus comprising:
an abnormal shadow candidate detection section for performing an image analysis of a medical image and for carrying out a detection of a candidate region for an abnormal shadow from the medical image; and
a judgment section for setting only a candidate region detected in the medical image more than once as a final result of detecting an abnormal shadow candidate when the detection is carried out by the abnormal shadow candidate detection section more than once.

2. The apparatus of claim 1, wherein the abnormal shadow candidate detection section carries out the detection more than once by one detection algorithm.

3. The apparatus of claim 1, wherein the abnormal shadow candidate detection section sets a plurality of threshold values for judging whether a region is the candidate region for the abnormal shadow and carries out the detection more than once based on each threshold value, and
the judgment section sets only the candidate region detected by the abnormal shadow candidate detection section more than once with respect to each threshold value as a final result of detecting the abnormal shadow candidate.

4. The apparatus of claim 1, wherein the abnormal shadow candidate detection section carries out the detection using each of a plurality of detection algorithms, and
the judgment section sets only the candidate region detected more than once by the detection of the abnormal shadow candidate detection section using each of the plurality of detection algorithms as a final result of detecting the abnormal shadow candidate.

5. A medical image processing apparatus comprising:
an abnormal shadow candidate detection section for performing an image analysis of a medical image and for carrying out a detection of a candidate region for an abnormal shadow from the medical image; and
an operation section for selecting any one of a first detection result in which only a candidate region detected in the medical image more than once is finally set as an abnormal shadow candidate and a second detection result in which a candidate region detected at least once is finally set as an abnormal shadow candidate, when the detection is carried out by the abnormal shadow candidate detection section more than once.

6. The apparatus of claim 5, further comprising a display section displaying the first or second detection result selected by the operation section.

7. The apparatus of claim 6, further comprising a switching display section for switching the first or second detection result which is displayed by the display section to the other detection result to display the other detection result.

8. The apparatus of claim 6, further comprising an identification display section for displaying the detection result so as to identify that which the detection result is displayed between the first detection result and the second detection result, when the first or second detection result is displayed by the display section.

9. The apparatus of claim 8, wherein the identification display section displays the detection result so as to identify that which the detection result is displayed by using different colors, when the first or second detection result is displayed.

10. The apparatus of claim 8, wherein the identification display section displays the detection result so as to identify that which the detection result is displayed by using different types of maker information indicating the first or second detection result, when the first or second detection result is displayed.

11. A program allowing the computer to realize:
a function for performing an image analysis of a medical image and for carrying out a detection of a candidate region for an abnormal shadow from the medical image by an abnormal shadow candidate detection section; and
a function for judging only a candidate region detected in the medical image more than once as a final result of detecting an abnormal shadow candidate when the detection is carried out by the abnormal shadow candidate detection section more than once.

12. A program allowing the computer to realize:
a function for performing an image analysis of a medical image and for carrying out a detection of a candidate region for an abnormal shadow from the medical image by an abnormal shadow candidate detection section; and
a function for selecting any one of a first detection result in which only a candidate region detected in the medical image more than once is finally set as an abnormal shadow candidate and a second detection result in which a candidate region detected at least once is finally set as an abnormal shadow candidate, when the detection is carried out by the abnormal shadow candidate detection section more than once, and for outputting the selected detection result.
